(19) United States
(12) Patent Application Publication
(10) Pub. No.: US 2006/0236390 A1
(43) Pub. Date: Oct. 19, 2006

(54) Method and system for detecting malicious wireless applications

(75) Inventors: Michael Matovsky, Toronto (CA); Brindusa L. Fritsch, Toronto (CA); Srimantee Karmakar, Mississauga (CA); Viera Bibr, Kilbride (CA); Jeffrey Christopher Rogers, Scarborough (CA); Michael Shenfield, Richmond Hill (CA); Kamen B. Vitanov, Mississauga (CA)

Correspondence Address: OGILVY RENAULT LLP, 1981 MCGILL COLLEGE AVENUE, SUITE 1600, MONTREAL, QC, H3A2Y3, CA

(73) Assignee: Research in Motion Limited, Waterloo (CA)

(21) Appl. No.: 11/107,725

(22) Filed: Apr. 18, 2005

(51) Int. Cl. G06F 12/14

(52) U.S. Cl. 726/22

(57) ABSTRACT

A method of managing a wireless application executing on terminal device of a wireless network. In accordance with the present invention, execution of the wireless application is monitored to detect symptoms of malicious operation. If one or more symptoms of malicious operation are detected, further operation of the wireless application is inhibited.

### CROSS-REFERENCE TO RELATED APPLICATIONS

This is the first application filed in respect of the present application.

### MICROFICHE APPENDIX

Not Applicable.

### TECHNICAL FIELD

The present invention relates to wireless communications, and in particular to a method and system for detecting and handling malicious wireless applications.

### BACKGROUND OF THE INVENTION

The number and variety of wireless terminal devices, such as mobile telephones, personal computers and PDAs with wireless communication capabilities, self service kiosks and two-way pagers is rapidly increasing. Software applications which run on these devices increase their utility. For example, a mobile phone may include an application which retrieves the weather for a range of cities, or a PDA may include an application that allows a user to shop for groceries. These software applications take advantage of wireless connectivity to a data network (such as the internet) in order to provide timely and useful services to users.

Referring to FIG. 1, a network facilitating the use of software-driven wireless terminal devices generally comprises an Application Gateway (AG) 2 coupled between a wireless network 4 and a data network 6, such as for example, the internet; and one or more wireless terminal devices 8 coupled to the wireless network 4, and hosted by the AG 2.

The AG 2 generally operates to mediate message flows between the terminal devices 8 and data services 10 accessible through the data network in the manner describe in Applicant's co-pending United States Patent Publications Nos. 2004/0215700 and 2004/0220998, the contents of both of which are incorporated herein by reference.

In general, the terminal devices 8 can be any of a wide variety of software-controlled wireless devices including, but not limited to mobile telephones, personal computers and PDAs with wireless communication capabilities, self service kiosks and two-way pagers. As is well known in the art, such devices generally comprise a microprocessor which operates under software control to provide the functionality of the terminal device 8.

As described in Applicant's co-pending United States Patent Publications Nos. 2004/0215700 and 2004/0220998, operation of the AG 2 enables a wireless application executing in a terminal device 8 to communicate with web services offered 10 through the data network 6. This operation may, for example, including accessing HTML content, and downloading files from back-end data sources (not shown) connected to the data network 6. In order to reduce device resource requirements, each wireless application provides User Interface (UI) functionality (for both display and user input) appropriate to the capabilities of the particular terminal device 8. At least a portion of the application logic is executed on the AG 2, so that signalling between the AG 2 and the terminal device 8 is limited to downloading application data for local storage and display on the terminal device 8, and uploading user inputs. The application logic executing on the AG 2 communicates with a web service 10 or back-end data source (not shown) on the data network 6, in response to the user input received from the terminal device 8, to provide the functionality of wireless application. This arrangement enables a user of the terminal device 8 to access and use the web service 10, but with reduced signalling traffic to/from the terminal device 8 to thereby limit wireless network bandwidth and device resource requirements.

As will be appreciated, most wireless applications are message driven. That is, wireless applications exchange messages with a host application gateway 2 (server) which performs the majority of the application logic. Such a system is vulnerable to high message traffic, especially on the terminal device 8, where the resources are most severely limited. Additionally, such message driven systems are vulnerable to message processing errors.

With the increasing popularity and functionality of wireless services, the risk of malicious mobile applications is also increasing. Malicious mobile applications can cause symptoms that can result in security threats, unnecessarily high signal traffic, exhaustion of resources (typically memory) on the terminal device and overall negative user experience. A high message traffic attack can cause denial-of-service on the AG 2 and potentially crash the terminal device 8.

For the purposes of the present application, the term “malicious mobile application” shall be understood to refer to any wireless application which generates an excessive volume of message traffic. In some cases, a malicious mobile application may be deliberate; for example a “Mobile Virus” which attempts to e-mail copies of itself to each person in a user's address book. In other cases, a malicious mobile application may the inadvertent result of poor programming; for example a wireless application capable of generating an infinite loop. In all cases, operation of the malicious mobile application results in the generation of excessive message traffic, which taxes bandwidth of the wireless network 4 and local resources of the terminal device 8.

To date, there have only been a limited number of cases of widespread mobile viruses. However, as terminal devices rapidly evolve, and become capable of running complex applications, there is an urgent need to protect both the data managed by mobile applications and the overall mobile user experience.

Accordingly, methods and systems for detecting and handling malicious wireless applications remains highly desirable.

### SUMMARY OF THE INVENTION

Accordingly, an object of the present invention is to provide methods and systems for detecting and handling malicious wireless applications.

Thus, an aspect of the present invention provides a method of managing a wireless application executing on terminal device of a wireless network. In accordance with the present invention, execution of the wireless application is monitored to detect symptoms of malicious operation. If one or more symptoms of malicious operation are detected, further operation of the wireless application is inhibited.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating a network in which the present invention may be deployed;

FIG. 2 is a block diagram schematically illustrating principal components and operation of a representative system in accordance with an embodiment of the present invention; and

FIGS. 3a and 3b are flowcharts illustrating principle steps in a method for handling potentially malicious wireless applications in accordance with a representative embodiment of the present invention.

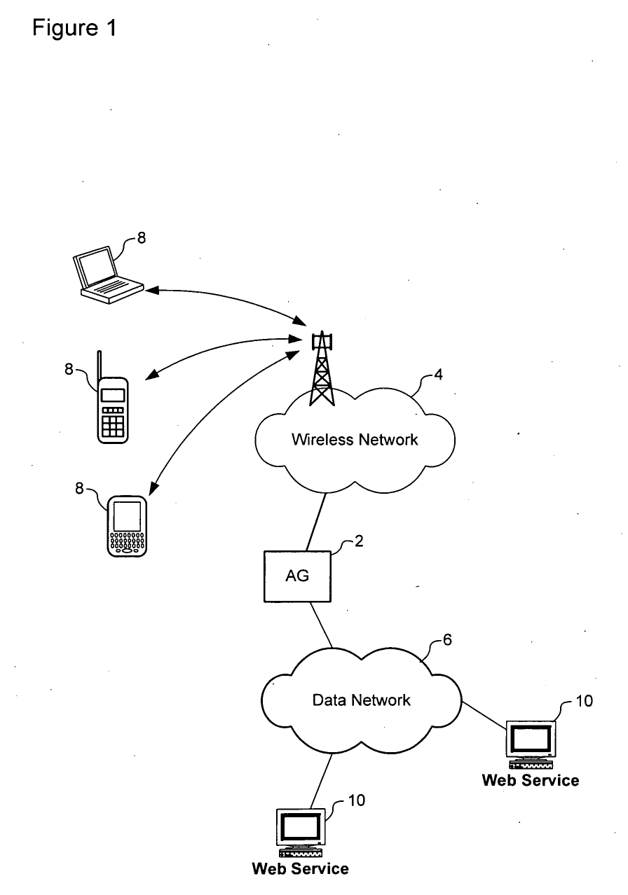

It will be noted that throughout the appended drawings, like features are identified by like reference numerals.

### DETAILED DESCRIPTION OF THE PREFERRED EMBODIMENT

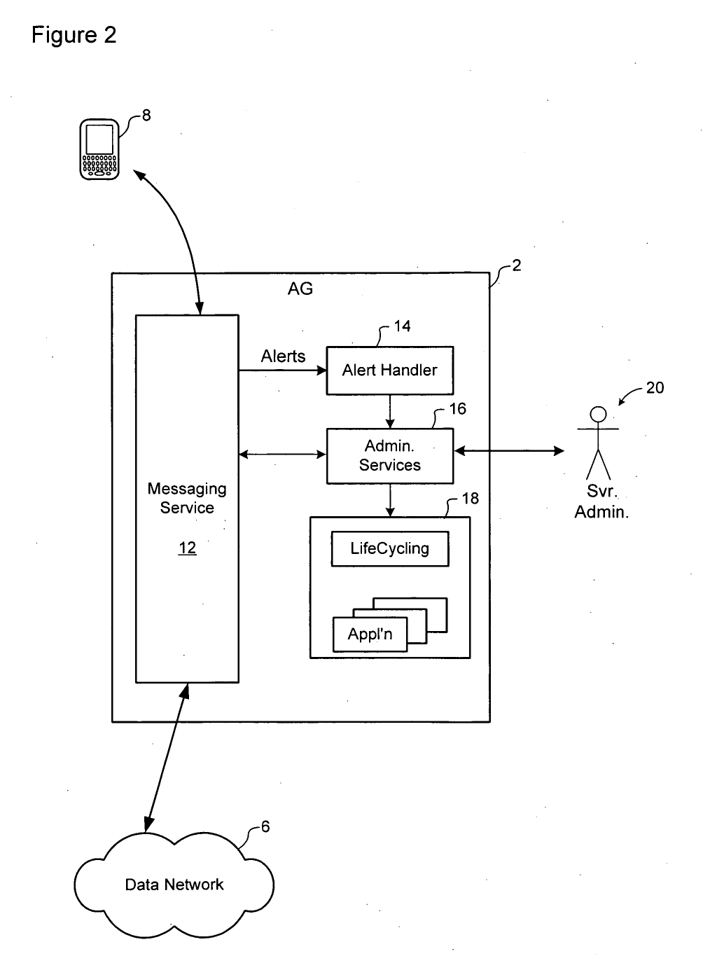

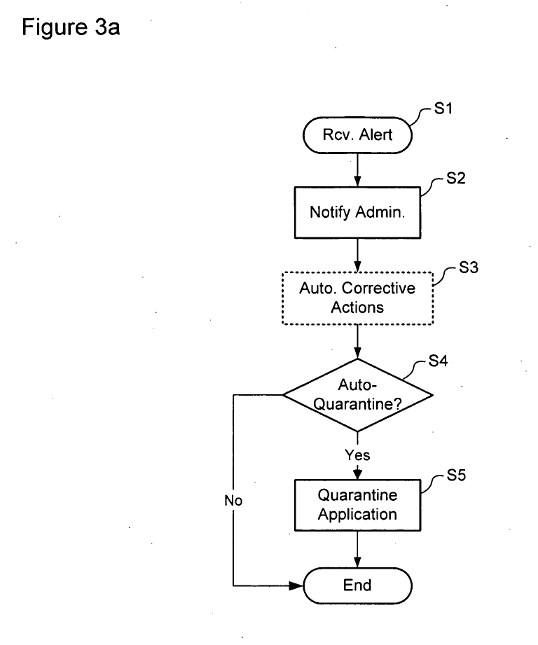

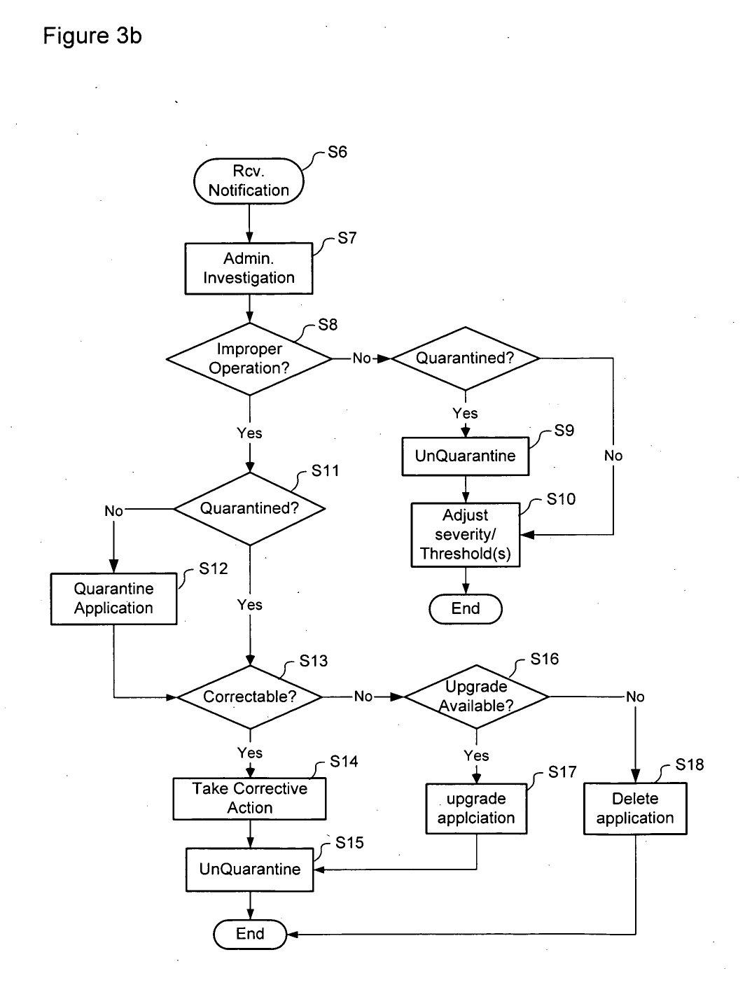

The present invention provides methods and systems for detecting and handling malicious wireless applications. A representative embodiment of the invention is described below, by way of example only, with reference to FIGS. 2 and 3.

As shown in FIG. 2, a system in accordance with a representative embodiment of the present invention comprises a messaging service 12; an alert handler 14 and an Administration Services system 16. These elements, each of which may be composed of any suitable combination of hardware and software, may conveniently be instantiated within the application gateway 2, but this is not necessary.

The Administration Services system 16 provides, among other things, a suite of lifecycling tools 18 by which a system administrator 20 can manage the operation of wireless applications executing on terminal devices 8 hosted by the application gateway 2. Representative lifecycling tools may, for example, provide functionality for: quarantining and un-quarantining a wireless application; forcing deletion of a wireless application; and forcing an upgrade of a wireless application based, for example, on upgrade scripts provided by an application developer. All of these functions will be described in greater detail below.

The messaging service 12 generally operates to monitor execution of each wireless application executing on a terminal device 8 hosted by the application gateway 2. As will be described in greater detail below, the messaging service 12 accumulates various execution metrics based on message flows and AG processing operations associated with the wireless application, and uses these execution metrics to detect symptoms of malicious operation of a wireless application. This approach is based on the premise that malicious applications produce recognisable symptoms, such as, for example: high message traffic; reoccurring message processing errors, for example due to improper use of back-end/servers); and repeated instantiation of the same data component or object, for example due to an infinite loop.

As may be appreciated, maintaining and analysing a complete historical record of the message flows and processing operations for each session of each wireless application executing on each one of a large number of hosted terminal devices is undesirably resource intensive, and therefore expensive. Accordingly, it is preferable to monitor the message flows and processing operations and accumulate various execution metrics, which are expected to be sensitive to malicious operation of a wireless application. Representative metrics include: a number of messages sent/received; a number and nature (e.g. back-end unavailable, back-end fault, internal error, etc) of processing errors; average, peak and current message flow rates (i.e. the number of messages sent/received per unit time) etc.

Each metric can then be compared (e.g. at regular intervals during a session) to a respective threshold value, which serves as an acceptable boundary on system behaviour. Threshold values may be set by the system administrator 20, or alternatively by an application developer. In cases where an application is not deliberately malicious, the latter option enables the threshold values to reflect the expected behaviour of the specific wireless application. In this case, threshold violations may indicate the presence of logic errors in the wireless application, and this information can be used by the application developer to develop improved versions of the application. When a threshold is violated, an alert is generated by the messaging service 12 and forwarded to the alert handler 14, which operates to trigger appropriate corrective action. Representative actions that may be taking in response to an alert message are described below with reference to FIGS. 3a and 3b.

As shown in FIG. 3a, when an alert message is received (step S1), the alert handler 14 forwards the alert message (along with information identifying at least the involved terminal device 8 and wireless application) to the system administrator 20 (step S2). This may, for example, be accomplished by way of an alert e-mail message. If desired, the alert handler 14 may also trigger (at S3) one or more methods of the administration services system 16 to implement auto-corrective actions and/or impose temporary restrictions on the involved wireless application, pending investigation by the system administrator 20. Representative auto-corrective actions may, for example, include forcing execution of a script that addresses a known issue with the application. Representative temporary restrictions may, for example, include restricting the allocation of bandwidth to the wireless application and/or limiting the flow rate of message traffic associated with the wireless application.

The alert handler can also determine (at S4) whether or not the wireless application should be quarantined pending investigation and resolution by the system administrator 20. This decision may, for example be based on a “severity level” of the alert. For example, the system administrator 20 may determine that certain metrics are particularly indicative of either the operation of malicious application code, or overall system performance. For these metrics, threshold violations will normally indicate that the overall operation of the application gateway 2 is being adversely affected, and may indicate the presence of a mobile virus. Accordingly, the system administrator 20 may assign a high severity level to these violations, which is included in the alert message generated by the messaging service 12. With this arrangement, the alert handler 14 can use the severity level to trigger automatic quarantining of any wireless application that violates a critical message flow or processing metric.

As may be seen in FIG. 3a, if the alert handler 14 determines that the wireless application should be quarantined (at S4), the alert handler 14 interacts with the administration services system 16 to trigger quarantining of the application (at S5).

In general, quarantining the application means that the application is prevented from sending or receiving messages, hence stopping it from performing any further malicious operations. Thus, execution of application logic on the AG 2 is frozen, and messaging to/from the terminal device 8 is blocked. In addition, any queued messages are saved, which facilitates investigation of the malicious behaviour by the system administrator 20. The application is kept in a “quarantined” state until the cause of the detected malicious behaviour (i.e. threshold violation) can be determined by the system administrator 20, and appropriate corrective action taken. Representative steps taken by the System administrator 20 and the administration services system 16 are described below with reference to FIG. 3b.

As shown in FIG. 3b, upon receipt (at S6) of the alert message from the alert handler 14, the system administrator may conduct an investigation (at S7) into the nature and cause of the malicious operation. For example, the system administrator 20 may determine whether or not the threshold violation actually represents improper or malicious operation of the wireless application (at step S8). If the wireless application is operating properly, then the alert message can be disregarded. If the application was quarantined at steps S4 and S5 above, then the application can also be “un-quarantined” (at Step S9). Un-quarantining the application re-enables the application to send and receive messages. Thus, execution of application logic on the AG 2 is allowed to resume, as is messaging to/from the terminal device 8. In addition, any queued messages can be released, so that the application can resume operation from the state it was in when it was quarantined. In addition, the system administrator 20 may also adjust (at step S10) the threshold value(s) used by the messaging service 12, and/or the severity level of the threshold violations, that gave rise to the original alert being sent to the alert handler 14. By adjusting threshold values, the system administrator 20 can prevent the messaging service 12 from generating spurious alerts. Adjusting the severity level allows the alert handler 14 to processes an alert generated by the messaging service 12, but without unnecessarily quarantining the application.

If an improper or malicious operation is found to have occurred (at step S8), then the system administrator 20 may determine (at Step S11), whether or not the wireless application has already been quarantined (i.e. by the alert handler 14). If not, then the system administrator 20 can force the application into quarantine (at S12). In either case, the system administrator 20 may determine (at Step S13), whether or not the wireless application can be repaired. If so, then the system administrator 20 can take appropriate repair steps (at Step S14) before un-quarantining the (repaired) application (at step S15). Representative repair may, for example, include forcing the download and execution of scripts to the involved terminal device that address known issues with the application, and/or update the execution state of the application so as to return the application to a healthy execution state. These operations, and the scripts that perform them, may, for example, be provided by the application developer based on known data components and application logic, and their intended execution states. If the wireless application cannot be repaired, then the system administrator 20 can determine whether or not there is an upgrade available for the wireless application (at step S16). If an update is available, the system administrator 20 may force installation of the upgrade (at step S17) before un-quarantining the (upgraded) application (at S15). On the other hand, if no upgrades are available, then the system administrator 20 can force deletion of the wireless application (step S18).

The embodiment(s) of the invention described above is(are) intended to be exemplary only. The scope of the invention is therefore intended to be limited solely by the scope of the appended claims.

We claim:

1. A method of managing a wireless application executing on a terminal device of a wireless network, the method comprising steps of:
monitoring execution of the wireless application to detect symptoms of malicious operation; and
if one or more symptoms of malicious operation are detected, inhibiting further operation of the wireless application.

2. A method as claimed in claim 1, wherein the step of monitoring execution of the wireless application comprises steps of:
accumulating one or more metrics associated with execution of the wireless application; and
comparing each metric to a respective predetermined threshold value.

3. A method as claimed in claim 2, wherein the metrics comprise any one or more of:
a number of messages sent/received;
a number of processing errors;
a type of processing error; and
a message flow rate.

4. A method as claimed in claim 1, wherein the step of inhibiting further operation of the wireless application comprises a step of forwarding an alert message to a system administrator.

5. A method as claimed in claim 1, wherein the step of inhibiting further operation of the wireless application comprises a step of triggering one or more auto-corrective actions.

6. A method as claimed in claim 5, wherein the step of triggering one or more auto-corrective actions comprises any one or more of:
limiting bandwidth allocated to the wireless application;
limiting a maximum permissible message flow rate of the wireless application; and
executing a script on the terminal device to address a known issue of the wireless application.

7. A method as claimed in claim 1, wherein the step of inhibiting further operation of the wireless application comprises a step of quarantining the wireless application.

8. A method as claimed in claim 7, wherein the step of quarantining the wireless application comprises a step of blocking messages of the wireless application to/from the terminal device.

9. A method as claimed in claim 8, wherein the terminal device is hosted by an application gateway executing application logic of the wireless application, and wherein the step of quarantining the wireless application further comprises a step of freezing execution of the application logic on the application gateway.

10. A method as claimed in claim 9, further comprising a step of saving queued messages of the wireless application.

11. A method as claimed in claim 7, wherein the step of quarantining the wireless application comprises steps of:
determining whether or not an upgrade of the wireless application is available; and
if an upgrade is available, forcing installation of the upgrade on the terminal device.

12. A method as claimed in claim 11, further comprising a step of forcing deletion of the wireless application if an upgrade is not available.

13. A method as claimed in claim 7, further comprising a step of subsequently un-quarantining the wireless application.
